(19) United States
(12) Patent Application Publication
(10) Pub. No.: US 2024/0281226 A1
(43) Pub. Date: Aug. 22, 2024

(54) SCRIPT COMPILATION METHOD AND COMPILER FOR PRIVACY-PRESERVING MACHINE LEARNING ALGORITHM

(71) Applicant: Alipay (Hangzhou) Information Technology Co., Ltd., Hangzhou (CN)

(72) Inventors: Long Fei ZHENG, Hangzhou (CN); Chao Chao CHEN, Hangzhou (CN); Li WANG, Hangzhou (CN)

(21) Appl. No.: 18/571,351

(22) PCT Filed: Jul. 12, 2022
(86) PCT No.: PCT/CN2022/105056

§ 371 Date: Dec. 18, 2023

(30) Foreign Application Priority Data
Aug. 25, 2021 (CN) 202110984175.0

(51) Int. Cl. G06F 8/41

(52) U.S. Cl. CPC G06F 8/41

(57) ABSTRACT

Embodiments of this specification provide a compilation method and a compiler for compiling a script of a privacy-preserving machine learning algorithm. In the compilation method, a compiler obtains a description script written in a predetermined format. The description script defines at least a computing formula in a privacy-preserving machine learning algorithm. The compiler determines several privacy algorithms for executing several operators used in the computing formula; obtains several code modules for executing the several privacy algorithms; and generates program code corresponding to the description script based on the several code modules.

This application claims priority to Chinese Patent Application No. 202110984175.0, filed with the China National Intellectual Property Administration on Aug. 25, 2021 and entitled “SCRIPT COMPILATION METHOD AND COMPILER FOR PRIVACY-PRESERVING MACHINE LEARNING ALGORITHM”, which is incorporated herein by reference in its entirety.

### TECHNICAL FIELD

One or more embodiments of this specification relate to the machine learning field, and in particular, to a script compilation method and a corresponding compiler for a privacy-preserving machine learning algorithm.

### BACKGROUND

With development of computer technologies, machine learning has been applied to various technical fields, to analyze and predict various service data. Data needed for machine learning usually relates to a plurality of platforms. For example, in a machine learning-based merchant classification and analysis scenario, an electronic payment platform has transaction data of a merchant, an electronic commerce platform stores sales data of the merchant, and a bank organization has debit and credit data of the merchant. Data usually exists in a form of an isolated island. Due to problems such as industry competition, data security, and user privacy, data integration is greatly hindered, and it is difficult to integrate data distributed on various platforms to train a machine learning model. Therefore, a requirement for developing a privacy-preserving machine learning algorithm is generated, to jointly train the machine learning model or perform joint service prediction by using a trained model, when it is ensured that privacy data of each party is not disclosed.

To develop the privacy-preserving machine learning algorithm, a developer not only needs to design an upper-layer machine learning algorithm, but also needs to learn of a bottom-layer privacy computing process of each operator. This imposes a high requirement for the developer, and implementation difficulty is very high.

Therefore, it is expected that there can be an improved solution, so that the developer can easily develop the privacy-preserving machine learning algorithm, and each platform can perform privacy-preserving joint machine learning.

### SUMMARY

One or more embodiments of this specification describe a compilation method and a compiler. A description script describing upper-layer machine learning algorithm logic can be compiled into security algorithm execution code for implementing each security operator based on a specific privacy algorithm, so that a developer can easily develop a privacy-preserving machine learning algorithm, thereby improving development efficiency.

According to a first aspect, a script compilation method is provided, and is performed by a compiler. The method includes:
obtaining a description script written in a predetermined format, where the description script defines at least a computing formula in a privacy-preserving machine learning algorithm;
determining several privacy algorithms for executing several operators used in the computing formula;
obtaining several code modules for executing the several privacy algorithms; and
generating program code corresponding to the description script based on the several code modules.

In an embodiment, the determining several privacy algorithms for executing several operators used in the computing formula specifically includes: parsing the computing formula to determine the several operators; and determining the several privacy algorithms for executing the several operators.

In a possible implementation, the description script further defines a privacy-preserving level of several parameters used in the computing formula, and the several operators include a first operator. In this case, a first privacy algorithm for executing the first operator can be determined based on a privacy-preserving level of a first parameter used in the first operator.

Further, in an embodiment, the privacy-preserving level includes a public parameter, a first privacy level in which a parameter is only visible to a holder, and a second privacy level in which a parameter is invisible to all participants.

In an embodiment, the determining a first privacy algorithm can specifically include: determining a first algorithm list available for executing the first operator; selecting, from the first algorithm list, several alternative algorithms whose computing parameter has a privacy-preserving level that conforms to the privacy-preserving level of the first parameter; and selecting the first privacy algorithm from the several alternative algorithms.

In a possible implementation, the method further includes: obtaining a performance indicator of a target computing platform that runs the machine learning algorithm. The several operators include a first operator. In this case, a first privacy algorithm for executing the first operator can be determined based on the performance indicator.

Further, in an embodiment, the determining a first privacy algorithm can specifically include: determining a first algorithm list available for executing the first operator; and selecting, from the first algorithm list as the first privacy algorithm, an algorithm whose resource requirement matches the performance indicator.

In a possible embodiment, the first privacy algorithm can be further determined based on the privacy-preserving level of the first parameter used in the first operator and the performance indicator of the target computing platform.

Further, the determining the first privacy algorithm can specifically include: determining a first algorithm list available for executing the first operator; selecting, from the first algorithm list, several alternative algorithms whose computing parameter has a privacy-preserving level that conforms to the privacy-preserving level of the first parameter; and selecting, from the several alternative algorithms as the first privacy algorithm, an algorithm whose resource requirement matches the performance indicator.

In an implementation scenario, the compiler runs on the target computing platform. In this case, the performance indicator can be obtained by reading a configuration file of the target computing platform.

In another implementation scenario, the compiler runs on a third-party platform. In this case, the performance indicator sent by the target computing platform can be received.

In a possible implementation, the generating program code corresponding to the description script can include: combining code segments in the several code modules based on computing logic of the computing formula, and subsuming the code segments into the program code.

In another possible implementation, the generating program code corresponding to the description script can include: obtaining interface information of several interfaces formed by packaging the several code modules; and generating, based on the interface information, invocation code for invoking the several interfaces, and subsuming the invocation code into the program code.

According to a second aspect, a compiler is provided, including:
a description script obtaining unit, configured to obtain a description script written in a predetermined format, where the description script defines at least a computing formula in a privacy-preserving machine learning algorithm;
a privacy algorithm determining unit, configured to determine several privacy algorithms for executing several operators used in the computing formula;
a code module obtaining unit, configured to obtain several code modules for executing the several privacy algorithms; and
a program code generation unit, configured to generate program code corresponding to the description script based on the several code modules.

According to a third aspect, a computer-readable storage medium is provided. The computer-readable storage medium stores a computer program, and when the computer program is executed on a computer, the computer is enabled to perform the method in the first aspect.

According to a fourth aspect, a computing device is provided, including a memory and a processor. The memory stores executable code, and when the processor executes the executable code, the method in the first aspect is implemented.

In the embodiments of this specification, a language adaptation layer is introduced between a machine learning algorithm layer and a security operator layer, and the language adaptation layer includes a compiler designed for a domain-specific language DSL. In this way, a developer can directly use the DSL to develop a privacy-preserving machine learning algorithm. Only logic of the machine learning algorithm needs to be described, to form a description script, and no bottom-layer security operator needs to be perceived. Then, the compiler compiles the description script into security algorithm execution code for implementing each security operator based on a specific privacy algorithm. In this way, the developer does not need to focus on a specific security operator or privacy algorithm, and a design only needs to be performed for the machine learning algorithm, to finally obtain execution code of the privacy-preserving machine learning algorithm, thereby greatly simplifying development difficulty and improve development effect.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following descriptions show merely some embodiments of this application, and a person of ordinary skill in the art can still derive other drawings from these accompanying drawings without creative efforts.

FIG. 1 is a schematic diagram illustrating an implementation layer of a privacy-preserving machine learning algorithm;

FIG. 2 is a schematic diagram illustrating an implementation layer of a privacy-preserving machine learning algorithm in an embodiment;

FIG. 3 is a flowchart illustrating a compilation method, according to an embodiment; and

FIG. 4 is a schematic structural diagram illustrating a compiler, according to an embodiment.

### DESCRIPTION OF EMBODIMENTS

The solutions provided in this specification are described below with reference to the accompanying drawings.

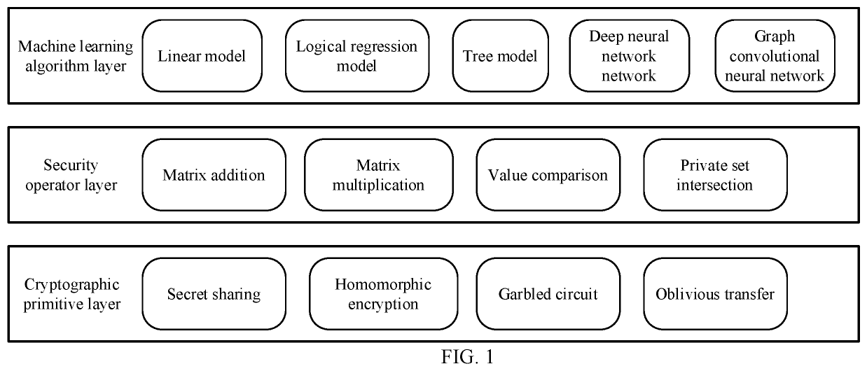

FIG. 1 is a schematic diagram illustrating an implementation layer of a privacy-preserving machine learning algorithm. An uppermost layer is a machine learning algorithm layer. A specific machine learning model, a training process of the model, and/or a use process are defined at the machine learning algorithm layer. For example, the machine learning model can be selected from a linear model, a logical regression model, a decision tree model (for example, a GBDT), a deep neural network (DNN), a graph convolutional neural network (GCN), etc.

The next layer is a security operator layer. A security operator is a basic operation that is abstracted from various machine learning algorithms and for which privacy preserving needs to be performed, including security matrix addition, security matrix multiplication, security value comparison, private set intersection (PSI), etc. Various machine learning algorithms can be disassembled into operation combinations of several security operators. For example, security matrix multiplication and matrix addition are repeatedly used for a plurality of times in a linear model and a logical regression model, and security value comparison is repeatedly used for a plurality of times in the decision tree model.

A bottom layer is a cryptographic primitive (primitive) layer, and includes a specific cryptographic basic principle used to implement an operation of the security operator, for example, includes secret sharing (SS), homomorphic encryption (HE), a garbled circuit (GC), and oblivious transfer (OT).

It should be understood that, one security operator can be implemented based on a plurality of different cryptographic primitives. For example, the security value comparison can be implemented by using the garbled circuit (some data is also exchanged in the garbled circuit through oblivious transfer (OT)), or can be implemented through secret sharing. The security matrix multiplication can be implemented through secret sharing or homomorphic encryption. Even if a security operator is implemented based on the same cryptographic primitive, there may be a plurality of different specific implementation processes. For example, in a process of implementing security matrix addition based on secret sharing, both parties that are to perform security matrix addition can directly perform a matrix sharding operation, or perform a matrix sharding operation by using a trusted third party, to finally obtain a sum matrix plaintext, or separately obtain a shard of a sum matrix, etc.

A specific implementation process or a specific computing manner of implementing a security operator based on a cryptographic primitive is referred to as a privacy algorithm. Because such a computing manner usually relates to multi-party computing, the privacy algorithm is sometimes referred to as a privacy computing protocol among a plurality of parties.

Based on an implementation layer of the privacy-preserving machine learning algorithm in FIG. 1, it can be assumed that when a developer wants to develop the privacy-preserving machine learning algorithm in a certain technical scenario, the developer not only needs to learn of various machine learning algorithms, to design an applicable upper-layer machine learning algorithm for a current technical scenario, but also needs to be familiar with various bottom-layer privacy algorithms for implementing various security operators, to develop, from top to bottom based on a current algorithm requirement, a set of code logic for implementing privacy-preserving machine learning. Because a specific security operator and a privacy algorithm need to be perceived, and such algorithms depend on a very professional cryptography technology, it is extremely difficult and inefficient to develop the privacy-preserving machine learning algorithm.

Therefore, in this embodiment of this specification, a solution is provided. A new compiler and compilation method are introduced, so that the developer develops the privacy-preserving machine learning algorithm.

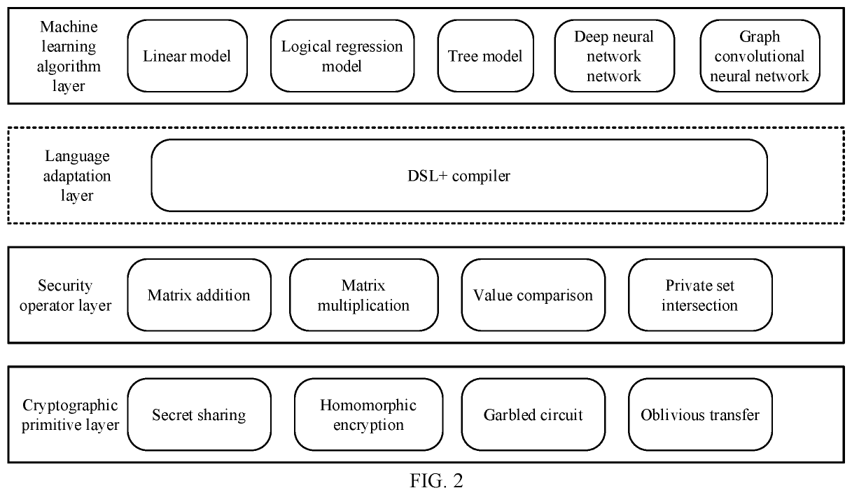

FIG. 2 is a schematic diagram illustrating an implementation layer of a privacy-preserving machine learning algorithm in an embodiment. In comparison with FIG. 1, it can be learned that a language adaptation layer is introduced between a machine learning algorithm layer and a security operator layer, and the language adaptation layer includes a compiler designed for a domain-specific language (DSL). In this way, a developer can directly use the DSL to develop a privacy-preserving machine learning algorithm. Only logic of the machine learning algorithm needs to be described, to form a description script, and no bottom-layer security operator needs to be perceived. Then, the compiler compiles the description script into security algorithm execution code for implementing each security operator based on a specific privacy algorithm. In this way, the developer does not need to focus on a specific security operator or privacy algorithm, and a design only needs to be performed for the machine learning algorithm, to finally obtain execution code of the privacy-preserving machine learning algorithm, thereby greatly simplifying development difficulty and improve development effect.

The following specifically describes a compilation method for implementing the above-mentioned functions and a compiler implemented based on this.

FIG. 3 is a flowchart illustrating a compilation method, according to an embodiment. The compilation method is used to compile a description script of a privacy-preserving machine learning algorithm. The method is performed by a compiler, and the compiler can be deployed in any apparatus, device, platform, or device cluster with a computing and processing capability. As shown in FIG. 3, the compilation method includes the following steps: Step 31: Obtain a description script written in a predetermined format, where the description script defines at least a computing formula in a privacy-preserving machine learning algorithm. Step 32: Determine several privacy algorithms for executing several operators used in the computing formula. Step 33: Obtain several code modules for executing the several privacy algorithms. Step 34: Generate program code corresponding to the description script based on the several code modules. The following describes in detail a specific execution process of the above-mentioned steps.

First, in step 31, the description script written in the predetermined format is obtained. It can be understood that the description script is a script that is written by a developer in a format needed by a compiler and that is used to describe the privacy-preserving machine learning algorithm. The predetermined format or the format needed by the compiler forms a DSL in the privacy algorithm field.

Usually, the description script of the privacy-preserving machine learning algorithm defines at least a parameter used in the privacy-preserving machine learning algorithm and a computing formula for performing computing based on the parameter.

For example, in an embodiment, a privacy-preserving machine learning algorithm that needs to be developed currently is used to jointly train a model between a party A and a party B. For such a machine learning algorithm, several parameters may be defined in a description script of the machine learning algorithm. For example, X_{A} represents a sample (for example, a user) feature held by the party A, W_{A} represents a model parameter for processing X_{A}, X_{B} represents a sample feature held by the party B, W_{B} represents a model parameter for processing X_{B}, y represents a predicted value, y′ represents a tag value, G_{A} represents a gradient used for W_{A}, G_{B} represents a gradient used for W_{B}, etc. All the parameters are represented in a matrix form (the predicted value and the label value are usually in a vector form, and can be considered as special matrices).

Based on the parameters, the following computing formula can be defined in the description script:

$$y = f 1 ( {W}_{A} , {X}_{A} , {W}_{B} , {X}_{B} ) \qquad ( 1 )$$

$${G}_{A} = f 2 ( y , {y}^{′} , {X}_{A} ) \qquad ( 2 )$$

$${G}_{B} = f 3 ( y , {y}^{′} , {X}_{B} ) \qquad ( 3 )$$

More specifically, when the model is a logical regression model, the function f1 in the computing formula (1) is specifically as follows:

$$f 1 ( {W}_{A} , {X}_{A} , {W}_{B} , {X}_{B} ) = sigmoid ( {X}_{A} * {W}_{A} + {X}_{B} * {W}_{B} ) \qquad ( 4 )$$

When the developer uses a likelihood-based loss function form, a computing formula of a gradient can be specifically as follows:

$$f 2 ( y , {y}^{′} , {X}_{A} ) = ( y - {y}^{′} ) * {X}_{A} \qquad ( 5 )$$

$$f 3 ( y , {y}^{′} , {X}_{B} ) = ( y - {y}^{′} ) * {X}_{B} \qquad ( 6 )$$

It can be understood that, a form of the computing formula is only an example. When another model is used, for example, a linear model, a tree model, etc. is used, a computing formula in another form is used in a model training process. Further, only the computing formula of the gradient is shown by using an example, and the model training process may further relate to more computing formulas such as a computing formula of a gradient update parameter. The computing formulas are not enumerated here.

In a possible implementation, a compiler and a DSL corresponding to the compiler have a predetermined privacy-preserving level, for example, a predetermined privacy-preserving form (for example, an encryption ciphertext form and a secret sharing shard form) in which all intermediate results and final output results in an algorithm operation process are invisible to all parties. Alternatively, it is predetermined that all intermediate results are in the privacy-preserving form, and a final output result is in a plaintext form, etc. In this way, the developer can select a corresponding compiler based on a requirement for a privacy-preserving level of the machine learning algorithm.

In another possible implementation, a compiler and a corresponding DSL support the developer to customize different privacy-preserving levels for each parameter in the algorithm. An example of an algorithm in which the party A and the party B perform joint model training is still used. Based on the example, the developer can set different privacy-preserving levels for the parameters such as X_{A}, X_{B}, W_{A}, and W_{B}.

In an embodiment, the privacy-preserving level can be divided into the following three levels: “Public” indicates a public parameter visible to all participants, “Private” indicates that a parameter is visible to only a holder (which may be referred to as a first privacy level), and “Secret” indicates that a parameter is invisible to all participants (which may be referred to as a second privacy level). In a case of such privacy-preserving level division, the developer can, for example, define the following privacy-preserving levels for the above-mentioned parameters:
Public lr
Private X_{A}, X_{B}
Secret W_{A}, W_{B}

Here, lr represents a learning rate, and is a hyperparameter in model learning.

In another embodiment, the privacy-preserving level can further have different division manners and have more or fewer levels. For example, in addition to the above-mentioned three levels, a third privacy level in which a parameter is visible to some participants and is invisible to some participants can be added.

It can be understood from the above-mentioned descriptions that the developer only needs to describe the algorithm logic of the machine learning algorithm by using the description script, that is, a specific parameter that is used (parameter definition), and an operation (computing formula) performed between parameters. Optionally, a privacy-preserving level of each parameter can be further defined. The developer does not need to have cryptography knowledge, and does not need to focus on how to implement the algorithm logic by using various cryptographic primitives. Instead, the description script is input into the compiler, and the compiler converts the description script into a specific implementation of a privacy algorithm.

The compiler is developed by a person skilled in a cryptography technology and a privacy-preserving algorithm. To implement the compilation function, a correspondence between a security operator and a privacy algorithm and implementation code of various privacy algorithms are preconfigured in the compiler. Then, the compiler compiles and converts the description script in step 32 to step 34 based on the correspondence and implementation code.

Specifically, after the DSL description script written by the developer of the machine learning algorithm is received, in step 32, the compiler parses the description script, and parses the computing formula into a combination of several operators. Then, for each operator, a privacy algorithm for executing the operator is determined.

For example, for the computing formula in the formula (4), an operation X_{A}*W_{A}+X_{B}*W_{B} can be parsed and split as follows: X_{A}*W_{A} and X_{B}*W_{B} are separately computed by using an operator of security matrix multiplication, to obtain two result matrices. Then, a sum of the two result matrices is computed by using an operator of security matrix addition. In this way, each computing formula in the description script can be parsed and split into a combination of several operators.

It can be understood that various operators can be implemented by using the cryptographic primitive and some privacy algorithms or privacy computing protocols. Therefore, a correspondence between a security operator and a privacy algorithm is configured in the compiler. A record can be used to implement a privacy algorithm of each operator. Based on the correspondence, for each operator obtained through parsing, the compiler can determine a privacy algorithm corresponding to the operator.

As described above, an operator can be implemented based on a plurality of specific privacy algorithms. Correspondingly, in the configured correspondence, some operators can have a plurality of corresponding privacy algorithms to form a privacy algorithm list. It is assumed that, an operator obtained through parsing in the computing formula is referred to as a first operator (for example, a matrix multiplication operator) below, and the first operator has a plurality of privacy algorithms in the correspondence configured by the compiler. In this case, the compiler can select, from the plurality of privacy algorithms as an execution algorithm of the first operator, a privacy algorithm that best matches a current requirement. The privacy algorithm is referred to as a first privacy algorithm below.

In a possible implementation, the compiler has a predetermined privacy-preserving level, and correspondingly, each preconfigured privacy algorithm has a privacy-preserving capability that matches the preconfigured privacy algorithm. In this case, in an embodiment, for the first operator, one privacy algorithm can be randomly selected as the first privacy algorithm from a plurality of privacy algorithms that can implement the operator.

In another embodiment, execution of the privacy algorithms needs to consume different quantities of resources. For example, different communication amounts and different computing amounts are needed. Correspondingly, for each privacy algorithm, the compiler records a resource requirement needed for executing the algorithm. In this case, a privacy algorithm of the first operator can be selected based on performance of a target computing platform that is to run the machine learning algorithm. Specifically, a performance indicator of the target computing platform that runs the machine learning algorithm can be obtained. The performance indicator can include a performance indicator of communication performance, for example, a network bandwidth and a network card configuration, and a performance indicator of computing performance, for example, a CPU configuration and a memory configuration. Then, the first privacy algorithm for executing the first operator is determined based on the performance indicator. Specifically, the compiler can determine, based on the correspondence, a first algorithm list available for executing the first operator; and select, from the first algorithm list as the first privacy algorithm, an algorithm whose resource requirement matches the performance indicator.

For example, a resource requirement of a certain privacy algorithm can indicate that to execute the privacy algorithm, two parties need to perform communication for n times, a basic operation needs to be executed for m times, etc. Based on this, duration needed when a computing platform with the performance indicator executes the privacy algorithm can be estimated. When the duration falls within a certain range, for example, is less than a threshold, it is considered that the resource requirement of the privacy algorithm matches the performance indicator, and therefore, the privacy algorithm is determined as the first privacy algorithm. Certainly, another matching algorithm can also be used. For example, matching is separately performed on the communication performance and the computing performance, and then a comprehensive matching degree is determined. In conclusion, a privacy algorithm that matches the computing performance can be determined by comparing a performance indicator of the target computing platform and a resource requirement of each privacy algorithm.

In different implementation scenarios, the target computing platform that runs the machine learning algorithm can be the same as or different from a platform on which the compiler is located. Specifically, in a scenario, the compiler also runs on the target computing platform. In this case, the compiler can read a configuration file of the target computing platform, to obtain the performance indicator. In another scenario, the compiler runs on a third-party platform, and the third-party platform can be referred to as a compilation platform. After developing the machine learning algorithm for the target computing platform and forming the description script, the developer can send the description script together with the performance indicator of the target computing platform to the compilation platform. Therefore, the compiler can receive the performance indicator sent by the target computing platform, and further select the privacy algorithm based on the performance indicator.

In a possible implementation, as described above, the compiler supports the developer to customize different privacy levels for various parameters in the algorithm. Correspondingly, for each privacy algorithm, the compiler records a privacy-preserving level of a computing parameter of the privacy algorithm. In this case, for any first operator, the compiler determines, based on a privacy-preserving level of a first parameter used in the first operator, a first privacy algorithm for executing the first operator.

Specifically, in an embodiment, the compiler can determine, by parsing the computing formula, the first parameter used in the first operator, and determine the privacy-preserving level of the first parameter with reference to customization of the privacy-preserving level of the parameter in the description script. In another aspect, the compiler can determine the first algorithm list available for executing the first operator; and select, from the first algorithm list, several alternative algorithms whose computing parameter has a privacy-preserving level that conforms to the privacy-preserving level of the first parameter. Further, one of the several alternative algorithms is selected as the first privacy algorithm.

For example, an example of the computing formula in the formula (4) is still used, and it is assumed that the first operator is a matrix multiplication operator for computing X_{A}*W_{A}, and the first parameter used in the first operator includes X_{A} and W_{A}. With reference to an example of customizing the privacy-preserving level of the parameter, it is assumed that the privacy-preserving level is divided into three levels. A privacy-preserving level of X_{A} is “Private”, and a privacy-preserving level of W_{A} is “Secret”.

In another aspect, in an example, the privacy algorithm that is configured in the compiler and that is used to execute the matrix multiplication operator includes an algorithm 1 to an algorithm 5 shown in Table 1, and Table 1 can be used as an example of the first algorithm list.

TABLE 1
Algorithm list for computing matrix multiplication

| Algorithm for | Privacy-preserving | Privacy-preserving |
|---|---|---|
| computing U*V | level of U | level of V |
| Algorithm 1 | Private | Private |
| Algorithm 2 | Public | Private |
| Algorithm 3 | Private | Secret |
| Algorithm 4 | Secret | Public |
| Algorithm 5 | Private | Secret |

Because X_{A}*W_{A} needs to be computed currently, and privacy-preserving levels of the first parameters X_{A} and W_{A} are respectively “Private” and “Secret”, in the above-mentioned algorithms, an algorithm that is used to compute privacy-preserving levels of the parameters (U and V) and that conforms to the privacy-preserving level of the first parameter includes an algorithm 3 and an algorithm 5, the algorithm 3 and the algorithm 5 can be used as alternative algorithms. Then, the compiler selects one of the alternative algorithms as the first privacy algorithm for executing the operator.

In an embodiment, the compiler selects any one of the alternative algorithms as the first privacy algorithm.

In another embodiment, the privacy algorithm of the first operator is further selected from the alternative algorithms with reference to the performance indicator of the target computing platform that runs the machine learning algorithm. In this embodiment, the compiler also obtains the performance indicator of the target computing platform. After the alternative algorithms are determined as described above, an algorithm whose resource requirement matches the performance indicator is selected from the alternative algorithms as the first privacy algorithm. For content and an obtaining manner of the performance indicator, and a matching manner of the resource requirement and the performance indicator, references can be made to the above-mentioned embodiments, and details are not described again.

In this way, in the above-mentioned manners, for each operator used in the computing formula, an applicable privacy algorithm can be separately determined.

Then, in step 33, the code module for executing the privacy algorithm is obtained. As described above, the code module can be pre-developed by a person skilled in cryptography. Therefore, in step 34, the program code corresponding to the description script can be generated based on the code module.

In an embodiment, code segments in all code modules corresponding to all operators can be combined based on the computing logic of the computing formula in the description script, and the code segments form program code. The program code formed in this way includes a code implementation body of each operator.

In another embodiment, the code modules can be packaged in advance to form an interface, which is referred to as an interface function. Each interface has corresponding interface information, for example, includes a function name of the interface function, a parameter quantity, a parameter type, etc. Correspondingly, in step 33, interface information of an interface corresponding to each operator can be obtained, invocation code for invoking a corresponding interface is generated based on the interface information, and the invocation code is included in the generated program code. In this embodiment, the formed program code may not include a code implementation body of each operator; instead, a corresponding code implementation body is invoked in an interface manner.

In this way, the program code corresponding to the description script is generated in the above-mentioned various manners. Typically, the same program language is used for the generated program code and a pre-developed code module for implementing various privacy algorithms. Usually, the program code can be advanced language code, for example, Java, or C, or intermediate code between an advanced language and a machine language, for example, assembly language code or byte code. A code language and a code form are not limited here.

It can be learned that, different from a conventional compiler that compiles high-level language code into lower-level code for machine execution, the compiler in this embodiment of this specification compiles, into security algorithm execution code for implementing each security operator based on a specific privacy algorithm, a description script describing upper-level machine learning algorithm logic. In this way, the developer does not need to focus on a specific security operator or privacy algorithm, and a design only needs to be performed for the machine learning algorithm, to finally obtain execution code of the privacy-preserving machine learning algorithm, thereby reducing development difficulty and improving development efficiency.

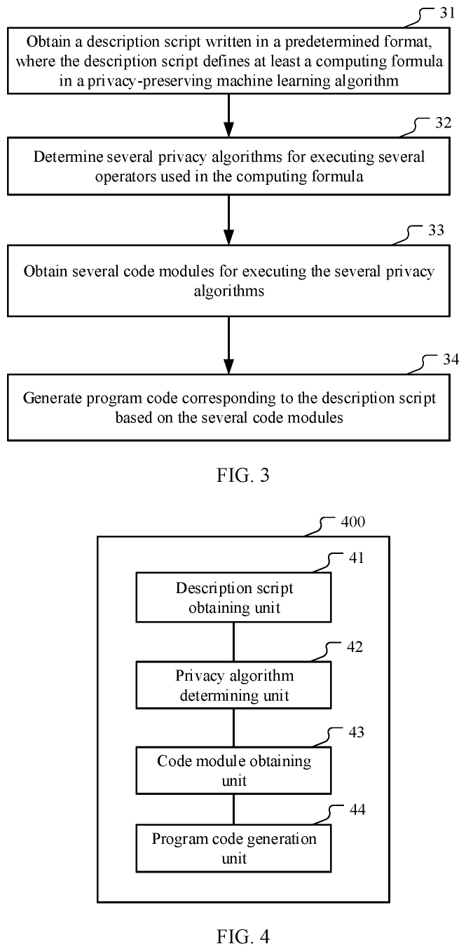

According to an embodiment of another aspect, a compiler is provided, to compile a script of a privacy-preserving machine learning algorithm. FIG. 4 is a schematic structural diagram illustrating a compiler, according to an embodiment. The compiler can be deployed in any device, platform, or device cluster with a data storage, computing and processing capability. As shown in FIG. 4, a compiler 400 includes:
a description script obtaining unit 41, configured to obtain a description script written in a predetermined format, where the description script defines at least a computing formula in a privacy-preserving machine learning algorithm;
a privacy algorithm determining unit 42, configured to determine several privacy algorithms for executing several operators used in the computing formula;
a code module obtaining unit 43, configured to obtain several code modules for executing the several privacy algorithms; and
a program code generation unit 44, configured to generate program code corresponding to the description script based on the several code modules.

According to an embodiment, the privacy algorithm determining unit 42 includes (not shown):
an operator parsing module, configured to parse the computing formula to determine the several operators; and
an algorithm determining module, configured to determine the several privacy algorithms for executing the several operators.

In a possible implementation, the description script further defines a privacy-preserving level of several parameters used in the computing formula, and the several operators include a first operator. In this case, the privacy algorithm determining unit 42 can be configured to determine, based on a privacy-preserving level of a first parameter used in the first operator, a first privacy algorithm for executing the first operator.

Further, in an embodiment, the privacy-preserving level can include a public parameter, a first privacy level in which a parameter is only visible to a holder, and a second privacy level in which a parameter is invisible to all participants.

In a specific embodiment, the privacy algorithm determining unit 42 is specifically configured to:
determine a first algorithm list available for executing the first operator;
select, from the first algorithm list, several alternative algorithms whose computing parameter has a privacy-preserving level that conforms to the privacy-preserving level of the first parameter; and
select the first privacy algorithm from the several alternative algorithms.

In a possible implementation, the compiler 400 further includes a performance indicator obtaining unit (not shown), configured to obtain a performance indicator of a target computing platform that runs the machine learning algorithm; the several operators include a first operator; and in this case, the privacy algorithm determining unit 42 can be configured to determine, based on the performance indicator, a first privacy algorithm for executing the first operator.

Further, in an embodiment, the privacy algorithm determining unit 42 can be specifically configured to:
determine a first algorithm list available for executing the first operator; and
select, from the first algorithm list as the first privacy algorithm, an algorithm whose resource requirement matches the performance indicator.

In a specific embodiment, the privacy algorithm determining unit 42 can be further configured to: determine the first privacy algorithm based on the privacy-preserving level of the first parameter used in the first operator and the performance indicator of the target computing platform.

Specifically, in an example, the privacy algorithm determining unit 42 can specifically perform the following steps:
determining a first algorithm list available for executing the first operator;
selecting, from the first algorithm list, several alternative algorithms whose computing parameter has a privacy-preserving level that conforms to the privacy-preserving level of the first parameter; and
selecting, from the several alternative algorithms as the first privacy algorithm, an algorithm whose resource requirement matches the performance indicator.

In an implementation scenario, the compiler 400 runs on the target computing platform. In this case, the performance indicator obtaining unit is configured to: read a configuration file of the target computing platform, and obtain the performance indicator.

In another implementation scenario, the compiler 400 runs on a third-party platform. In this case, the performance indicator obtaining unit is configured to receive the performance indicator sent by the target computing platform.

In an embodiment, the program code generation unit 44 is configured to: combine code segments in the several code modules based on computing logic of the computing formula, and subsume the code segments into the program code.

In another embodiment, the program code generation unit 44 is configured to:
obtain interface information of several interfaces formed by packaging the several code modules; and
generate, based on the interface information, invocation code for invoking the several interfaces, and subsume the invocation code into the program code.

The compiler can compile, into security algorithm execution code for implementing each security operator based on a specific privacy algorithm, the description script describing upper-layer machine learning algorithm logic, thereby simplifying a development process of the developer.

According to an embodiment of another aspect, a computer readable storage medium is further provided, on which a computer program is stored. When the computer program is executed in a computer, the computer is caused to perform the method described with reference to FIG. 3.

According to an embodiment of still another aspect, a computing device is further provided and includes a memory and a processor. Executable code is stored in the memory, and when executing the executable code, the processor implements the method with reference to FIG. 3.

A person skilled in the art should be aware that in the above-mentioned one or more examples, functions described in this application can be implemented by hardware, software, firmware, or any combination thereof. When these functions are implemented by software, they can be stored in a computer-readable medium or transmitted as one or more instructions or code on the computer-readable medium.

The above-mentioned some specific implementations further describe the purposes, technical solutions, and beneficial effects of this specification. It should be understood that the foregoing descriptions are merely some specific implementations of this specification and are not intended to limit the protection scope of this specification. Any modification, equivalent replacement, or improvement made based on the technical solutions of this specification shall fall within the protection scope of this specification.

1. A script compilation method, performed by a compiler, wherein the method comprises:
obtaining a description script written in a predetermined format, wherein the description script defines at least a computing formula in a privacy-preserving machine learning algorithm;
determining a plurality of privacy algorithms for executing a plurality of operators used in the computing formula;
obtaining a plurality of code modules for executing the plurality of privacy algorithms; and
generating program code corresponding to the description script based on the plurality of code modules.

2. The method according to claim 1, wherein determining the plurality of privacy algorithms for executing the plurality of operators used in the computing formula comprises:
parsing the computing formula to determine the plurality of operators; and
determining the plurality of privacy algorithms for executing the plurality of operators.

3. The method according to claim 1, wherein the description script further defines a privacy-preserving level of a plurality of parameters used in the computing formula, and the plurality of operators comprise a first operator; and
determining the plurality of privacy algorithms for executing the plurality of operators used in the computing formula comprises:
determining, based on a privacy-preserving level of a first parameter used in the first operator, a first privacy algorithm for executing the first operator.

4. The method according to claim 3, wherein the privacy-preserving level comprises a public parameter, a first privacy level in which a parameter is only visible to a holder, and a second privacy level in which a parameter is invisible to all participants.

5. The method according to claim 3, wherein determining a first privacy algorithm for executing the first operator comprises:
determining a first algorithm list available for executing the first operator;
selecting, from the first algorithm list, a plurality of alternative algorithms whose computing parameter has a privacy-preserving level that conforms to the privacy-preserving level of the first parameter; and
selecting the first privacy algorithm from the plurality of alternative algorithms.

6. The method according to claim 1, further comprising: obtaining a performance indicator of a target computing platform that runs the machine learning algorithm, wherein the plurality of operators comprise a first operator; and
determining the plurality of privacy algorithms for executing the plurality of operators used in the computing formula comprises:
determining, based on the performance indicator, a first privacy algorithm for executing the first operator.

7. The method according to claim 6, wherein determining a first privacy algorithm for executing the first operator comprises:
determining a first algorithm list available for executing the first operator; and
selecting, from the first algorithm list as the first privacy algorithm, an algorithm whose resource requirement matches the performance indicator.

8. The method according to claim 3, further comprising: obtaining a performance indicator of a target computing platform that runs the machine learning algorithm; and
determining a first privacy algorithm for executing the first operator comprises:
determining the first privacy algorithm based on the privacy-preserving level of the first parameter used in the first operator and the performance indicator of the target computing platform.

9. The method according to claim 8, wherein determining the first privacy algorithm comprises:
determining a first algorithm list available for executing the first operator;
selecting, from the first algorithm list, a plurality of alternative algorithms whose computing parameter has a privacy-preserving level that conforms to the privacy-preserving level of the first parameter; and
selecting, from the plurality of alternative algorithms as the first privacy algorithm, an algorithm whose resource requirement matches the performance indicator.

10. The method according to claim 6, wherein the compiler runs on the target computing platform; and
obtaining a performance indicator of a target computing platform that runs the machine learning algorithm comprises: reading a configuration file of the target computing platform, and obtaining the performance indicator.

11. The method according to claim 6, wherein the compiler runs on a third-party platform; and
obtaining a performance indicator of a target computing platform that runs the machine learning algorithm comprises: receiving the performance indicator sent by the target computing platform.

12. The method according to claim 1, wherein generating program code corresponding to the description script based on the plurality of code modules comprises:
combining code segments in the plurality of code modules based on computing logic of the computing formula, and subsuming the code segments into the program code.

13. The method according to claim 1, wherein generating program code corresponding to the description script based on the plurality of code modules comprises:
obtaining interface information of a plurality of interfaces formed by packaging the plurality of code modules; and
generating, based on the interface information, invocation code for invoking the plurality of interfaces, and subsuming the invocation code into the program code.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A computing device, comprising a memory and a processor, wherein the memory stores executable instructions that, in response to execution by the processor, cause the processor to:
obtain a description script written in a predetermined format, wherein the description script defines at least a computing formula in a privacy-preserving machine learning algorithm;
determine a plurality of privacy algorithms for executing a plurality of operators used in the computing formula;
obtain a plurality of code modules for executing the plurality of privacy algorithms; and
generate program code corresponding to the description script based on the plurality of code modules.

27. A non-transitory computer-readable storage medium, comprising instructions stored therein that, when executed by a processor of a computing device, cause the processor to:
obtain a description script written in a predetermined format, wherein the description script defines at least a computing formula in a privacy-preserving machine learning algorithm;
determine a plurality of privacy algorithms for executing a plurality of operators used in the computing formula;
obtain a plurality of code modules for executing the plurality of privacy algorithms; and
generate program code corresponding to the description script based on the plurality of code modules.

28. The computing device according to claim 26, wherein the processor being caused to determine the plurality of privacy algorithms for executing the plurality of operators used in the computing formula includes being caused to:
parse the computing formula to determine the plurality of operators; and
determine the plurality of privacy algorithms for executing the plurality of operators.

29. The computing device according to claim 26, wherein the description script further defines a privacy-preserving level of a plurality of parameters used in the computing formula, and the plurality of operators comprise a first operator; and
wherein the processor being caused to determine the plurality of privacy algorithms for executing the plurality of operators used in the computing formula includes being caused to:
determine, based on a privacy-preserving level of a first parameter used in the first operator, a first privacy algorithm for executing the first operator.

30. The computing device according to claim 26, wherein the processor is further caused to: obtain a performance indicator of a target computing platform that runs the machine learning algorithm, wherein the plurality of operators comprise a first operator; and
wherein the processor being caused to determine the plurality of privacy algorithms for executing the plurality of operators used in the computing formula includes being caused to:
determine, based on the performance indicator, a first privacy algorithm for executing the first operator.

31. The non-transitory computer-readable storage medium according to claim 27, wherein the processor being caused to determine the plurality of privacy algorithms for executing the plurality of operators used in the computing formula includes being caused to:
parse the computing formula to determine the plurality of operators; and
determine the plurality of privacy algorithms for executing the plurality of operators.

32. The non-transitory computer-readable storage medium according to claim 27, wherein the description script further defines a privacy-preserving level of a plurality of parameters used in the computing formula, and the plurality of operators comprise a first operator; and
wherein the processor being caused to determine the plurality of privacy algorithms for executing the plurality of operators used in the computing formula includes being caused to:
determine, based on a privacy-preserving level of a first parameter used in the first operator, a first privacy algorithm for executing the first operator.
